(19) United States
(12) Patent Application Publication
(10) Pub. No.: US 2016/0209809 A1
(43) Pub. Date: Jul. 21, 2016

(54) HOLOGRAPHIC DISPLAY DEVICE

(71) Applicant: ELECTRONICS AND TELECOMMUNICATIONS RESEARCH INSTITUTE, Daejeon (KR)

(72) Inventors: Yong Hae Kim, Daejeon (KR); Chi-Sun Hwang, Daejeon (KR); Gi Heon Kim, Daejeon (KR); Himchan Oh, Seoul (KR); Hojun Ryu, Seoul (KR); Chunwon Byun, Daejeon (KR); Myung Lae Lee, Daejeon (KR); Jae Won Lee, Seoul (KR); Jae-Eun Pi, Daejeon (KR)

(21) Appl. No.: 14/994,029

(22) Filed: Jan. 12, 2016

(30) Foreign Application Priority Data
Jan. 15, 2015 (KR) 10-2015-0007392
Nov. 10, 2015 (KR) 10-2015-0157615

(51) Int. Cl. G03H 1/30; G02F 1/1335; G02F 1/1343; G03H 1/22

(52) U.S. Cl. CPC G03H 1/30; G03H 1/2294; G02F 1/133553; G02F 1/134336; G03H 2001/303

(57) ABSTRACT

Provided is a holographic display device. The holographic display device includes a light source unit configured to emit a light, and a spatial light modulator (SLM) configured to modulate at least one of a phase and amplitude of the light emitted from the light source unit to output a hologram image, and including a plurality of pixel groups that are arranged in a first direction, wherein each of the plurality of pixel groups includes: first pixels arranged in a matrix x1×y1 and providing an image having a first wavelength, and second pixels adjacent to the first pixels in the first direction, arranged in a matrix x2×y2, and providing an image having a second wavelength that is different from the first wavelength.

### CROSS-REFERENCE TO RELATED APPLICATIONS

This U.S. non-provisional patent application claims priority under 35 U.S.C. §119 of Korean Patent Application Nos. 10-2015-0007392, filed on Jan. 15, 2015, and 10-2015-0157615, filed on Nov. 10, 2015, the entire contents of which are hereby incorporated by reference.

### BACKGROUND

The present disclosure relates to a holographic display device, and more particularly, to a holographic display device that implements a color hologram with a simplified configuration.

In recent, studies on stereo (3D) images and image reproduction technologies are being performed. Typical 2D image systems provide planar images but 3D image systems are image reproduction technologies that show, to users, actual image information that objects have.

In order to reproduce a color hologram, an analogue hologram is being mostly used. The analogue hologram uses the continuous gradation (amplitude or phase) and color of a film to reproduce a hologram image. Since the analogue hologram using the film is implemented on a film, it is possible to implement only a still image. An analogue color hologram is implemented through a rainbow hologram or a reflection hologram that has been developed by Denisyuk.

The rainbow hologram uses a slit having a narrow cut to record an object and has an advantage in that it is also possible to see it even in a significantly bright place because the brightness of its image is high. Also, since the reflection hologram uses a Bragg reflection characteristic due to a fringe in a film to select a reflection wavelength, it is possible to reproduce a color hologram by using white lighting.

In order to reproduce dynamic hologram images, a spatial light modulator (SLM) is used. In the case that a continuous gradation is needed, an SLM using liquid crystals is used, and in the case that a binary gradation is needed, an SLM using a digital micro-mirror device (DMD).

In order to implement the dynamic color hologram, three SLMs and red, blue and green lasers for color implementation should be used. The red laser passes through a first SLM that reproduces a red hologram, the green laser passes through a second SLM that reproduces a green hologram, and the blue laser passes through a third SLM that reproduces a blue hologram. 3D images may be implemented by the composition of three lights that pass through the first to third SLMs. Besides such a technique, it is also possible to use red, blue and green lasers, a shutter that selects any one of three lasers, and a single SLM capable of being time-division driven to implement the dynamic color hologram.

However, since the pixel size of an SLM that uses the liquid crystal or the DMD is only about 5 um to about 10 um so far, it is difficult to provide a satisfiable viewing angle in reproducing hologram images.

### SUMMARY

The present disclosure provides a holographic display device that implements a color hologram with a simplified configuration.

An embodiment of the inventive concept provides a holographic display device including a light source unit configured to emit a light, and a spatial light modulator (SLM) configured to modulate at least one of a phase or amplitude of the light emitted from the light source unit to output a hologram image, and including a plurality of pixel groups that are arranged in a first direction, wherein each of the plurality of pixel groups includes: first pixels arranged in a matrix x1×y1 (where x1 and y1 are positive integers equal to or larger than 2) and providing an image having a first wavelength, and second pixels adjacent to the first pixels in the first direction, arranged in a matrix x2×y2(where x2 and y2 are positive integers equal to or larger than 2), and providing an image having a second wavelength that is different from the first wavelength.

In an embodiment, each of the plurality of pixel groups may further include third pixels that are adjacent to the second pixels in the first direction, arranged in a x3×y3 matrix (where x3 and y3 are positive integers equal to or larger than 2), and provide an image having a third wavelength that is different from the first wavelength and the second wavelength.

In an embodiment, the image having the first wavelength may be a blue image, the image having the second wavelength may be a green image, and the image having the third wavelength may be a red image.

In an embodiment, a pitch between a first pixel group, any one of the plurality of pixel groups and a second pixel group adjacent to the first pixel group may be defined as a first pitch, and the first pitch may be smaller than RX calculated by Equation (1):

$$RX = π \times \frac{1}{180} \times \frac{1}{60} \times Dst \qquad ( 1 )$$

where Dst is a distance between the holographic display device a preset virtual user who watches the holographic display device.

In an embodiment, the SLM may include a first base substrate, a light reflection layer disposed on the first base substrate, a wavelength conversion layer disposed on the light reflection layer, a pixel electrode disposed on the wavelength conversion layer, a liquid crystal layer disposed on the pixel electrode, and a common electrode disposed on the liquid crystal layer.

In an embodiment, the wavelength conversion layer may include a first wavelength conversion layer disposed to overlap with the first pixels, and a second wavelength conversion layer disposed to overlap with the second pixels, and a thickness of the first wavelength conversion layer and a thickness of the second wavelength conversion layer may be different from each other.

In an embodiment, the thickness of the first wavelength conversion layer may be an integer multiple of half the first wavelength, and the thickness of the second wavelength conversion layer may be an integer multiple of half the second wavelength.

In an embodiment, the pixel electrode may include a transparent material.

In an embodiment, the wavelength conversion layer may include a first material layer, and a second material layer having a refractive index different from the first material layer, and the first material layer and the second material layer may be alternately stacked one or more times.

In an embodiment, each of the first material layer and the second material layer may include an inorganic material.

In an embodiment, the first material layer may include metal and the second material layer may include an inorganic material.

In an embodiment, the first material layer may have a first thickness, and the second material layer may have a second thickness thicker than the first thickness.

In an embodiment, a light provided by the light source unit may be a white light.

In an embodiment, the hologram image may be a color hologram image.

In an embodiment, first x1 pixels arranged in a row direction among the first pixels may be arranged in the first direction, and first y1 pixels arranged in a column direction among the first pixels may be arranged in a second direction intersecting with the first direction, second x2 pixels arranged in a row direction among the second pixels may be arranged in the first direction, and second y2 pixels arranged in a column direction among the second pixels may be arranged in a second direction, and the number of the first y 1 pixels arranged in the second direction among the first pixels may be a same as the number of the second y2 pixels arranged in the second direction among the second pixels.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a schematic diagram of a holographic display device that may display a hologram image according to an embodiment of the inventive concept;

FIG. 2 is a schematic block diagram of a spatial light modulator (SLM) according to an embodiment of the inventive concept;

FIG. 3 is a schematic plan view of an SLM according to an embodiment of the inventive concept;

FIG. 4 is a schematic plan view of a single pixel group in FIG. 3;

FIG. 5 is a schematic side view of a holographic display device according to an embodiment of the inventive concept and a preset virtual user;

FIG. 6 is a schematic cross-sectional view of an SLM according to an embodiment of the inventive concept; and

FIG. 7 is a schematic plan view of an SLM according to an embodiment of the inventive concept.

### DETAILED DESCRIPTION

Since the inventive concept may implement various changes and have many forms, particular embodiments are illustrated in the drawings and described in detail in the detailed description. However, the inventive concept is not intended to be limited to particular, disclosed embodiments and it should be understood that the present disclosure covers all changes, equivalents, and replacements that fall within the spirit and technical scope of the inventive concept. Also, parts irrelevant to the inventive concept in the drawings are omitted in order to clarify the description of the inventive concept.

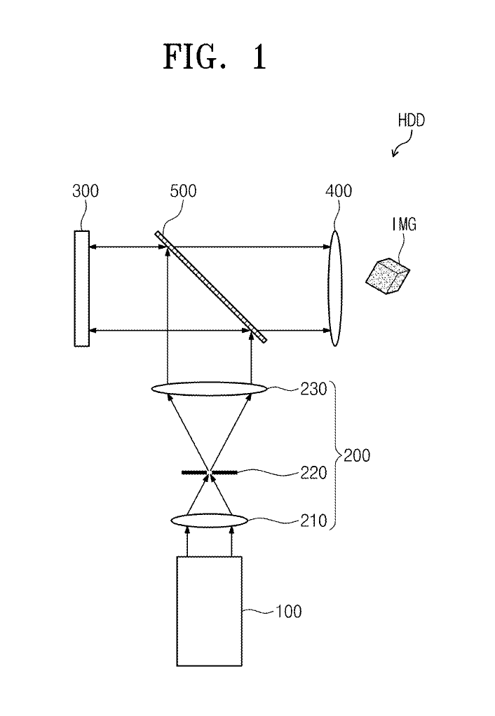

FIG. 1 is a schematic diagram of a holographic display device that may display a hologram image according to an embodiment of the inventive concept.

A holographic display device HDD may include a light source unit 100, a first optical system 200, a spatial light modulator (SLM) 300, a second optical system 400, and a beam splitter 500.

The light source unit 100 emits a light. The light source unit 100 may be a laser light source that generates a laser light having a coherent nature, or a LED light source. In an embodiment of the inventive concept, the light source unit 100 may emit a mixed light having a mixed color. More particularly, the light source unit 100 may emit a white light.

The first optical system 200 provides the light emitted from the light source unit 100 to the SLM 300. The first optical system 200 performs a function of evenly emitting the light emitted from the light source unit 100 to the front of the beam splitter 500.

The first optical system 200 may include a focusing lens 210, a filter 220, and a magnification lens 230. A light passing through the focusing lens 210 may pass through the pin hole HL of the filter 220. The light passing through the pin hole HL of the filter 220 may pass through the magnification lens 230 to increase a diameter, and evenly enter the front of the beam splitter 500. The distances between the focusing lens 210, the filter 220, and the magnification lens 230 may be appropriately adjusted.

The beam splitter 500 may emit the incident light to the SLM 300. The beam splitter 500 generates the interference of the light reflected from the SLM 300 and the incident light from the first optical system 200 and emits it to the second optical system 400.

While reflecting the incident light, the SLM 300 may modulate at least one of a phase or amplitude to display a color hologram image IMG. Although FIG. 1 shows e.g., a reflective SLM 300, the embodiment is not limited thereto.

The color hologram image IMG may be displayed at the front end of the SLM 300. In this case, a user views the hologram image IMG that has the light-emitting surface of the SLM 300 as the background. In order to prevent the user from distortedly viewing the color hologram image IMG, the light-emitting surface of the SLM 300 may be viewed as a white image by the user. Related detailed descriptions are provided below.

The second optical system 400 focuses a light passing through the SLM 300 on the position of a user.

According to an embodiment of the inventive concept, it is possible to implement a color hologram by using a single light source unit 100 and a single SLM 300. Related detailed descriptions are provided below.

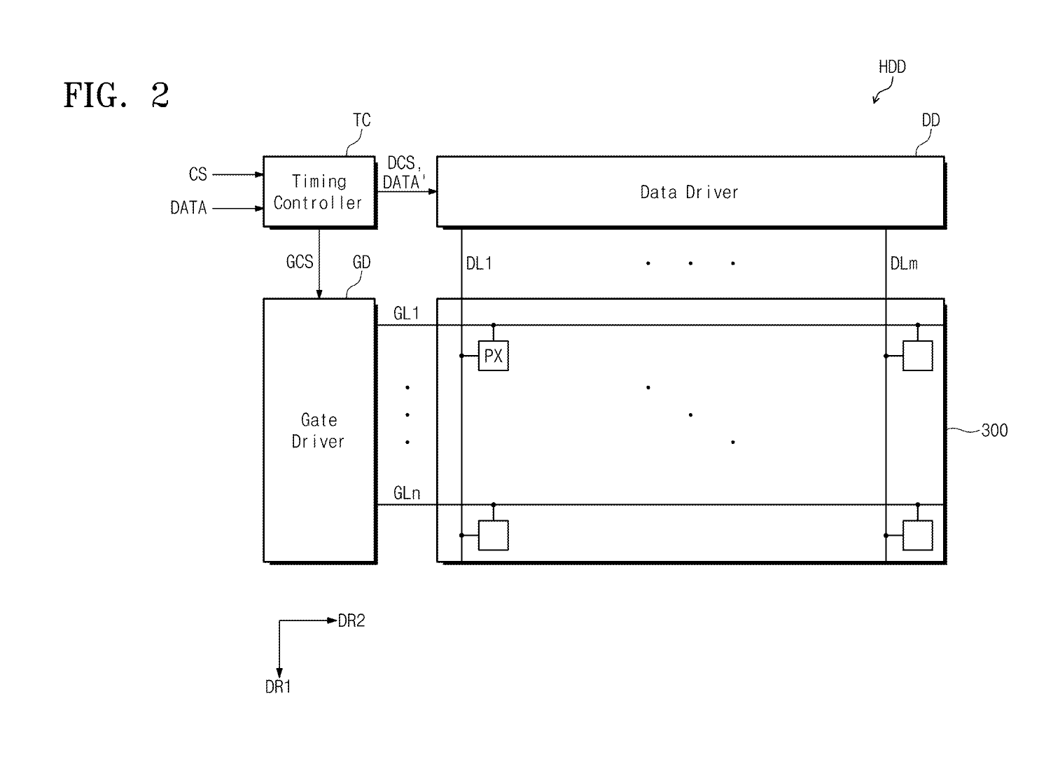

FIG. 2 is a schematic block diagram of an SLM according to an embodiment of the inventive concept.

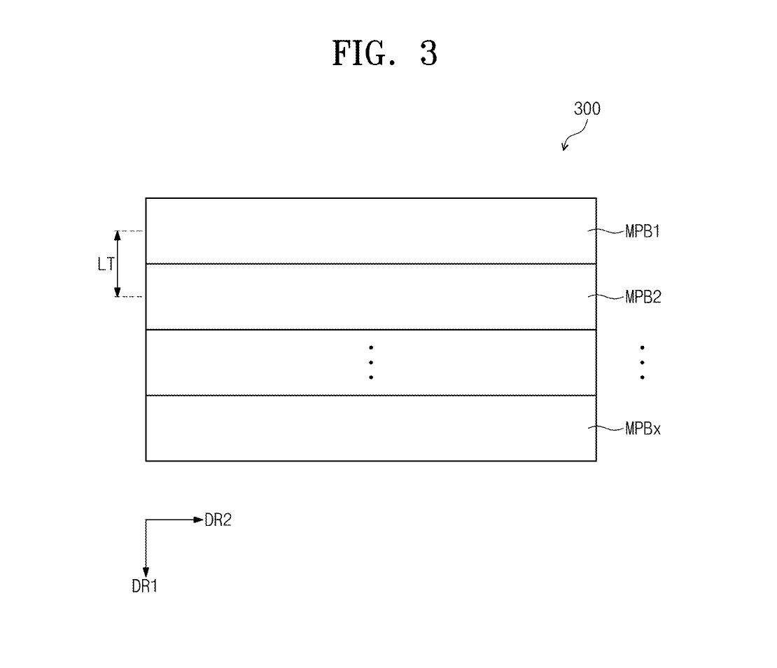

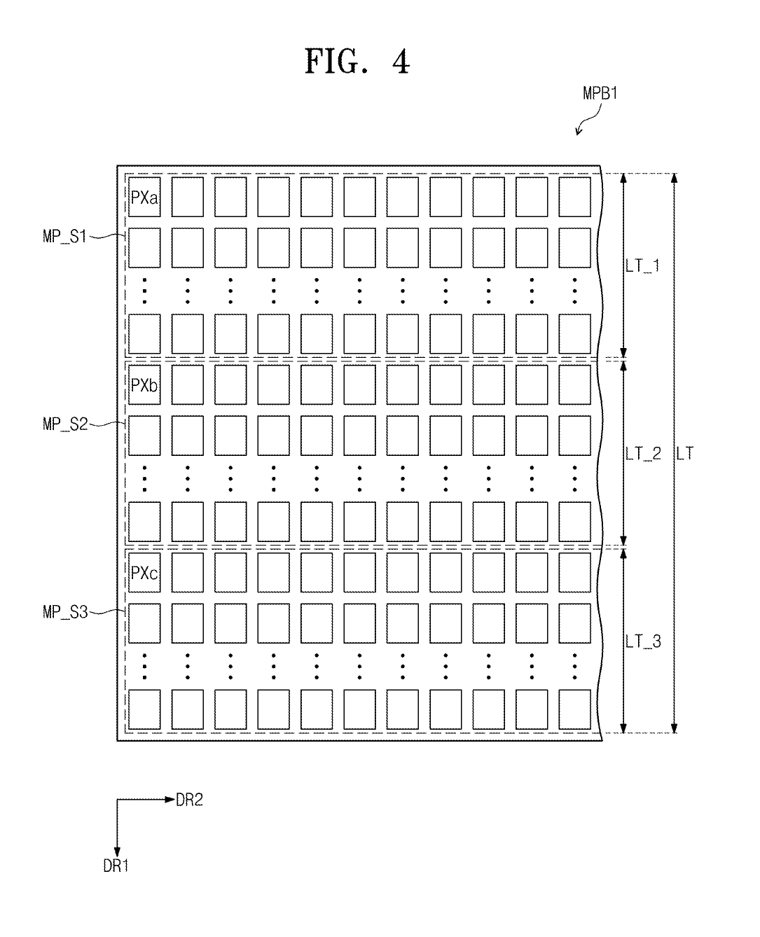

Referring to FIG. 2, the SLM 300 may include a plurality of data lines DL1 to DLm, a plurality of gate lines GL1 to GLn, and a plurality of pixels PX. The pixels PX may be divided into a plurality of groups, and related descriptions are provided in FIGS. 3 and 4. FIG. 2 illustrates a pixel PX that is connected to a first data line DL1 and a first gate line GL1.

Each of the plurality of data lines DL1 to DLm may be extended in a first direction DR1, and each of a plurality of gate lines GL1 to GLn may be extended in a second direction DR2 that intersects with the first direction DR1. The plurality of data lines DL1 to DLm and the plurality of gate lines GL1 to GLn define pixel regions, each of which may include the pixel PX.

The holographic display device HDD may include a timing controller TC for driving the SLM 300, a data driver DD, and a gate driver GD.

The timing controller TC receives a plurality of control signals CS and data signals DATA from the outside of the holographic display device HDD. The data signal DATA may include information on an interference fringe. The timing controller TC may convert the data signal DATA so that the converted data matches with the specification of the data driver DD, and output the converted data signal DATA′ to the data driver DD.

The timing controller TC generates a gate control signal GCS and a data control signal DCS in response to a control signal CS provided from the outside.

The gate control signal GCS is a control signal for controlling the operation timing of the gate driver GD. The timing controller TC may output the gate control signal GCS to the gate driver GD. The data control signal DCS is a control signal for controlling the operation timing of the data driver DD. The timing controller TC may output the data control signal DCS to the data driver DD.

The gate driver GD outputs gate signals in response to the gate control signal GCS. The gate lines GL1 to GLn receives gate signals from the gate driver GD. The gate signals are provided to the pixels PX of the SLM 300 through the gate lines GL1 to GLn.

The data driver DD generates a data voltage. In particular, the data driver DD converts and outputs the converted data signal DATA′ into data voltages in response to the data control signal DCS.

FIG. 3 is a schematic plan view of an SLM according to an embodiment of the inventive concept, and FIG. 4 is a schematic plan view of a single pixel group in FIG. 3.

Referring to FIGS. 3 and 4, the SLM 300 may include a plurality of pixel groups MPB1 to MPBx.

The plurality of pixel groups MPB1 to MPBx may be arranged side by side in the first direction DR1 and each of the plurality of pixel groups MPB1 to MPBx may be extended in the second direction DR2.

FIG. 4 shows a first pixel group MPB1 among the plurality of plurality of pixel groups MPB1 to MPBx. Remaining pixel groups MPB2 to MPBx that are not shown among the plurality of pixel groups MPB1 to MPBx may include substantially the same configuration as the first pixel group MPB1.

The first pixel group MPB1 may be divided into a first pixel region MP_S1, a second pixel region MP_S2, and a third pixel region MP_S3. Although FIG. 4 illustrates that the first pixel group MPB1 has three pixel regions, the first to third pixel regions MP_S1 to MP_S3, the embodiment is not limited thereto. For example, in another embodiment of the inventive concept, the first pixel group MPB1 may also include only two pixel regions, and in still another embodiment, the first pixel group MPB1 may also include four or more pixel regions.

The first pixel region MP_S1, the second pixel region MP_S2, and the third pixel region MP_S3 may be sequentially arranged in the first direction DR1. Since remaining pixel groups MPB2 to MPBx has substantially the same configuration as the first pixel group MPB1, the first pixel region MP_S1, the second pixel region MP_S2, and the third pixel region MP_S3 may be sequentially, repetitively arranged in the SLM 300.

First pixels PXa may be arranged on the first pixel region MP_S1, second pixels PXb may be arranged on the second pixel region MP_S2, and third pixels PXc may be arranged on the third pixel region MP_S3.

The first pixels PXa may provide an image having a first wavelength, the second pixels PXb may provide an image having a second wavelength, and the third pixels PXc may provide an image having a third wavelength. The first wavelength, the second wavelength, and the third wavelength may be different from one another. For example, the image having the first wavelength may be a blue image, the image having the second wavelength may be a green image and the image having the third wavelength may be a red image. However, these are exemplary and the color of an image having each wavelength may vary.

The first pixels PXa, the second pixels PXb, and the third pixels PXc may be arranged in the form of a matrix. For example, the first pixels PXa may have the form of a matrix in which x1 pixels may be arranged in the first direction DR1 and y1 pixels may be arranged in the second direction DR2, and the second pixels PXb may have the form of a matrix in which x2 pixels may be arranged in the first direction DR1 and y2 pixels may be arranged in the second direction DR2, and the third pixels PXc may have the form of a matrix in which x3 pixels may be arranged in the first direction DR1 and y3 pixels may be arranged in the second direction DR2. That is, the row direction may be defined as the first direction DR1 and the column direction may be defined as the second direction DR2.

The x1 to x3, and y1 to y3 all may be are integers equal to or larger than 2. In particular, the numbers y1 to y3 of pixels that are arranged in the second direction DR2 intersecting with the first direction DR1 in which the plurality of pixel groups MPB1 to MPBx are arranged may be the same. The numbers x1 to x3 may be determined according to the width LT of the first pixel group MPB1 in the first direction DR1 and the pitch of the first to third pixels PXa to PXc in the first direction DR1.

The width LT of the first pixel group MPB1 may be substantially the same as the pitch LT between two adjacent pixel groups among the plurality of pixel groups MPB1 to MPBx. FIG. 3 illustrates the pitch LT between the first pixel group MPB1 and the second pixel group MPB2.

At the first pixels PXa of the first pixel region MP_S1, lights that are reflected from the first x1 pixels PXa arranged in the first direction may cause interference, and lights that are reflected from the first y1 pixels PXa arranged in the second direction DR2 may cause interference. The second pixels PXb of the second pixel region MP_S2 and the third pixels PXc of the third pixel region MP_S3 may also cause interference like the first pixels PXa of the first pixel region MP_S1.

In the case that unlike the embodiment of the inventive concept, pixels that reflect lights having different wavelengths are disposed in a single pixel region, the pitch between pixels that reflect lights having the same wavelength that cause interference increases and thus a viewing angle may decrease. However, according to an embodiment of the inventive concept, the pixels (e.g., first pixels PXa) that reflect lights having the same wavelength that cause interference are closely disposed in the same pixel region (e.g., first pixel region MP_S1). Thus, the pitch between pixels that reflect lights having the same wavelength that cause interference does not increase. As a result, even when a color hologram image having a plurality of wavelengths is displayed with a single SLM 300, it is possible to prevent a decrease in viewing angle.

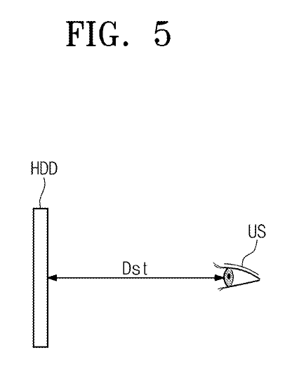

FIG. 5 is a schematic side view of a holographic display device according to an embodiment of the inventive concept and a preset virtual user.

Referring to FIGS. 4 and 5, the width LT of each of the pixel groups MPB1 to MPBx may be determined by the distance Dst between a holographic display device HDD and a preset virtual user US that watches the holographic display device HDD. As described in FIGS. 3 and 4 above, since the pitch LT between the pixel groups MPB1 to MPBx may be substantially the same as the width of each of the pixel groups MBP1 to MPBx, the pitch LT between the pixel groups MPB1 to MPBx may also be determined by the distance Dst between the holographic display device HDD and the preset virtual user US that watches the holographic display device HDD. In the following, how to set the width LT of each of the pixel groups MPB1 to MPBx is described as an example, which may also be equally applied to the pitch LT between the pixel groups MPB1 to MPBx.

The width LT of each of the pixel groups MPB1 to MPBx may be smaller than a value RX that is calculated by Equation (1):

$$RX = π \times \frac{1}{180} \times \frac{1}{60} \times Dst . \qquad ( 1 )$$

Specifically, the hologram image IMG (in FIG. 1) of the holographic display device HDD displays the SLM 300 as the background. When the user US views the background color displayed by the light-emitting surface of the SLM 300 as a color excluding a white color, a phenomenon may occur in which a color hologram image IMG (in FIG. 1) is distorted. Thus, in order to be capable of preventing the color hologram image IMG (in FIG. 1) from becoming distorted, it is possible to set the width LT of each of the pixel groups MPB1 to MPBx.

The width LT of each of the pixel groups MPB1 to MPBx may be set so that the user US views the background color displayed by the SLM 300 as the white color. In order to view the background color as the white color, the user US needs to identify lights reflected from the first pixel region MP_S1, the second pixel region MP_S2, and the third pixel region MP_S3. That is, the width LT of each of the pixel groups MPB1 to MPBx needs to have a value smaller than the distance that may be identified according to the resolution of the user US. The resolution of the eyes of the user US may be about 1′ (minute). The value RX calculated by Equation (1) is the minimum distance that may be identified according to the resolution of the user US.

The minimum distance that may be identified according to the resolution of the user US may vary according to the distance Dst between the user US and the holographic display device HDD. Thus, it is possible to set the minimum viewing distance Dst that enables the user to view a hologram image IMG (in FIG. 1), and then calculate the distance RX that may be identified by the user US accordingly.

The distance Dst between the user US and the holographic display device HDD may be the recommended minimum viewing distance. For example, the recommended minimum viewing distance Dst may be about 1 m. In this case, the RX calculated through Equation (1) may be about 290 um. Thus, the width LT of each of the pixel groups MPB1 to MPBx may be smaller than about 290 um. That is, the sum of the first width LT_1, second width LT_2, and third width LT_3 of the first to third pixel regions MP_S1 to MP_S3 may be designed to be smaller than about 290 um.

Each of the first width LT_1, the second width LT_2, and the third width LT_3 may be about 90 um. In this case, the number of pixels that are arranged in the first direction of each of the first pixel PXa, the second pixel PXb, and the third pixel PXc may be determined according to the pitch of the first direction DR1 of each of the first pixel PXa, the second pixel PXb, and the third pixel PXc. The pitch of the first direction DR1 of each of the first pixel PXa, the second pixel PXb, and the third pixel PXc may be about 1 um to about 10 um. However, the figures are only examples and the embodiment is not limited thereto. In the following, an example where the pitch of each of the first pixel PXa, the second pixel PXb, and the third pixel PXc is about 1 um is described. In this case, since the first width LT_1 is about 90 um, 90 first pixels PXa may be arranged in the first direction DR1 on the first pixel region MP_S1. Thus, the number x1 above may be 90. Also, the number x2 of the second pixels PXb of the second pixel region MP_S2, and the number x3 of the third pixels PXc of the third pixel region MP_S3 may be 90. Thus, it is possible to form a hologram image while about 90 pixels arranged in the first direction DR1 of each of the first to third pixel regions MP_S1 to MP_S3 cause interference.

Since the width LT of each of the pixel groups MPB1 to MPBx has a value smaller than the minimum distance RX that may be identified by the user US, the user US may mix the background color displayed by the SLM 300 with the light reflected from the first pixel region MP_S1, the light reflected from the second pixel region MP_S2, and the light reflected from the third pixel region MP_S3 to view the mixed light as the white background. Thus, in the case that the user US watches the holographic display device HDD at a distance equal to or longer than the minimum viewing distance Dst, it is possible to a color hologram image IMG (in FIG. 1) displayed in front of the SLM 300 that displays the white background on its light-emitting surface.

The sum of the first width LT_1 of the first direction DR1 of the first pixel region MP_S1, the second width LT_2 of the first direction DR1 of the second pixel region MP_S2, and the third width LT_3 of the first direction DR1 of the third pixel region MP_S3 may be substantially the same as the width LT of each of the pixel groups MPB1 to MPBx. Although the embodiment describes an example where the first width LT_1, the second width LT_2, and the third width LT_3 are the same one another, it is not limited thereto. For example, the first width LT_1, the second width LT_2, and the third width LT_3 may also be different from one another according to a product design.

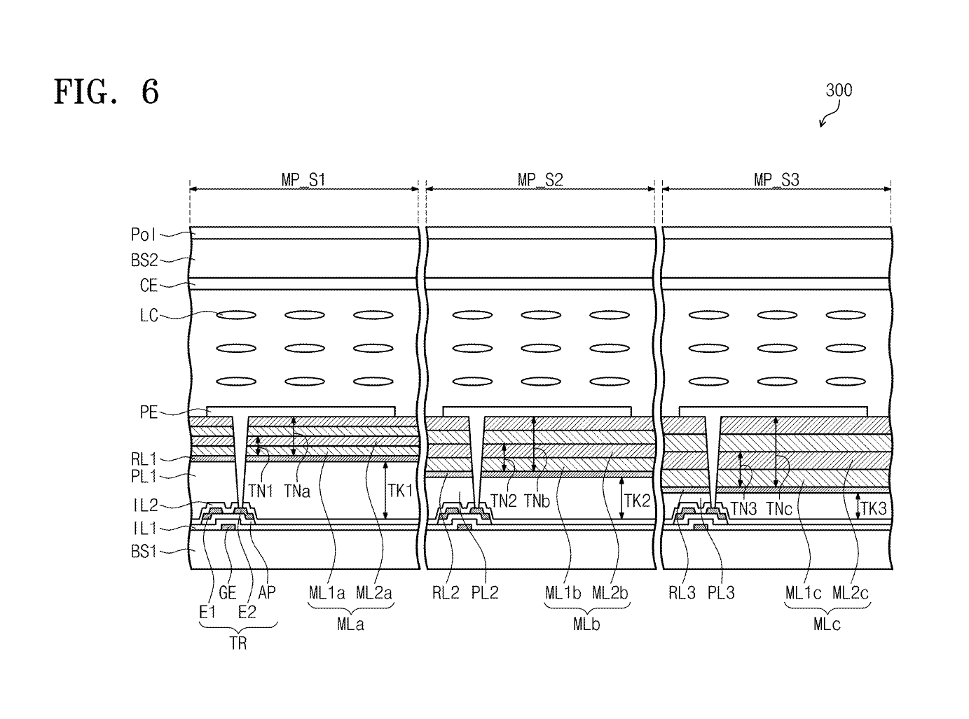

FIG. 6 is a schematic cross-sectional view of an SLM according to an embodiment of the inventive concept.

Referring to FIG. 6, the SLM 300 may include a first base substrate BS1, a second base substrate BS2, a transistor TR, light reflection layers RL1 to RL3, wavelength conversion layers MLa to MLc, a pixel electrode PE, a liquid crystal layer LC, and a common electrode CE.

The first base substrate BS1 and the second base substrate BS2 may face each other and especially, the second base substrate BS2 may have a property that enables the transmission of light.

The transistor TR may be disposed on the first base substrate BS1. The transistor TR may include a gate electrode GE, an active pattern AP, a first electrode E1, and a second electrode E2. The active pattern AP may be disposed on the gate electrode GE, with a first insulating layer IL1 therebetween. The first electrode E1 is branched from any one of data lines DL1 to DLm (in FIG. 2) to be in contact with the active pattern AP, and the second electrode E2 is in contact with the active pattern AP at an interval from the first electrode E1. A second insulating layer IL2 may cover the transistor TR.

Planarization layers PL1 to PL3 may be disposed on the second insulating layer IL2. A first planarization layer PL1 that has a first thickness TK1 may be disposed on the first pixel region MP_S1, a second planarization layer PL2 that has a second thickness TK2 may be disposed on the second pixel region MP_S2, and a third planarization layer PL3 that has a third thickness TK3 may be disposed on the third pixel region MP_S3. The first to third planarization layers PL1 to PL3 may have different thicknesses.

A first light reflection layer RL1 may be disposed on the first planarization layer PL1, a second light reflection layer RL2 may be disposed on the second planarization layer PL2, and a third light reflection layer RL3 may be disposed on the third planarization layer PL3. Each of the first to third light reflection layers RL1 to RL3 may include a metallic material, such as aluminum and reflect an externally incident light.

A first wavelength conversion layer MLa may be disposed on the first light reflection layer RL1 of the first pixel region MP_S1, a second wavelength conversion layer MLb may be disposed on the second light reflection layer RL2 of the second pixel region MP_S2, and a third wavelength conversion layer MLc may be disposed on the third light reflection layer RL3 of the third pixel region MP_S3. The thicknesses of the first to third wavelength conversion layers ML1 to MLc may be different from one another.

The first to third wavelength conversion layers MLa to MLc may include first material layers ML1a to ML1c and second material layers ML2a to ML2c, respectively. The first material layers ML1a to ML1c and the second material layers ML2a to ML2c may include transparent materials that have different refraction indexes. The first material layers ML1a to ML1c and the second material layers ML2a to ML2c may include transparent inorganic materials. For example, the first material layers ML1a to ML1c and the second material layers ML2a to ML2c may include any one of materials, such as SiN, SiO₂, TiN, AlN, TiO₂, Al₂O₃, SnO₃, WO₃, and ZrO₂ and another one. However, these materials are examples and each of the first material layers ML1a to ML1c and the second material layers ML2a to ML2c may include materials other than the above-described materials. For example, the first material layers ML1a to ML1c may include metal and the second material layers ML2a to ML2c may include inorganic materials. In this case, the thicknesses of the first material layers ML1a to ML1c may be thinner than those of the second material layers ML2a to ML2c. The thicknesses of the first materials ML1a to ML1c may be so thin that lights may pass through them. Although the fact that the first material layers ML1a to ML1c include metal is described as an example, the embodiment is not limited thereto. For example, in another embodiment of the inventive concept, the second material layers ML2a to ML2c may include metal and the first material layers ML1a to ML1c may include inorganic materials. The first material layers ML1a to ML1c and second material layers ML2a to ML2c are alternately stacked on the first to third wavelength conversion layers MLa to MLc, respectively. Each of the first to third wavelength conversion layers MLa to MLc may have a distributed Bragg reflector (DBR) structure.

The first thickness TN1 of the first material layer ML1a and the second material layer ML2a of the first pixel region MP_S1 may be half the first wavelength that a light reflected from the first pixel region MP_S1 has. Thus, a light that enters the pixel electrode PE is reflected from the first light reflection layer RL1 and is emitted back to the pixel electrode PE may have an optical path corresponding to the first wavelength. In this case, a light having the first wavelength may increase in reflectivity due to constructive interference and lights having wavelengths excluding the first wavelength may disappear due to destructive interference. Thus, the light having the first wavelength may be easily reflected from the first pixel region MP_S1. The total thickness TNa of the first wavelength conversion layer MLa may be integer multiples of half the first wavelength.

FIG. 6 shows, as an example, a structure in which the first material layers ML1a to ML1c and the second material layers ML2a to ML2c are alternately stacked twice. However, the embodiment is not limited thereto. In another embodiment of the inventive concept, the first material layers ML1a to ML1c and the second material layers ML2a to ML2c may also be stacked only once and in still another embodiment, it is also possible to have a structure in which they are stacked three times or more.

The second thickness TN2 that is the sum of the first material layer ML1b and the second material layer ML2b of the second pixel region MP_S2 may be substantially the same as the thickness of half a second wavelength. Thus, the total thickness TNb of the second wavelength conversion layer MLb may be integer multiples of half the second wavelength. As a result, the reflectivity of a light having the second wavelength on the second pixel region MP_S2 may be enhanced.

The third thickness TN3 that is the sum of the first material layer ML1c and the second material layer ML2c of the third pixel region MP_S3 may be substantially the same as the thickness of half a third wavelength. Thus, the total thickness TNc of the third wavelength conversion layer MLc may be integer multiples of half the third wavelength. As a result, the reflectivity of a light having the third wavelength on the third pixel region MP_S3 may be enhanced.

A blue light may be reflected from the first pixel region MP_S1, a green light may be reflected from the second pixel region MP_S2 and a red light may be reflected from the third pixel region MP_S3. In the embodiment, since the numbers of times the first material layers ML1a to ML1c and the second material layers ML2a to ML2c of each of the first to third wavelength conversion layers MLa to MLc are repeated are the same, the thickness TNa of the first wavelength conversion layer MLa that reflects the first wavelength, the shortest wavelength may be thinnest. However, the embodiment is not limited thereto. For example, in another embodiment of the inventive concept, the numbers of times the first material layers ML1a to ML1c and the second material layers ML2a to ML2c are repeated may vary according to the first to third pixel regions MP_S1 to MP_S3. In this case, the thicknesses of the first wavelength conversion MLa, the second wavelength conversion layer MLb, and the third wavelength conversion layer MLc may not be in proportion to wavelengths.

The pixel electrode PE may be disposed on each of the first to third wavelength conversion layers MLa to MLc.

To discuss the pixel electrode PE disposed on the first pixel region MP_S1 as an example, the pixel electrode PE may be electrically connected to the second electrode E2 through a contact hole that passes through the first wavelength conversion layer MLa, the second insulating layer IL2, and the first planarization layer PL1.

The common electrode CE may face the pixel electrode PE, with a liquid crystal layer LC therebetween. The common electrode CE may be disposed under the second base substrate BS2. The pixel electrode PE and the common electrode CE may form an electric field on the liquid crystal layer LC.

The pixel electrode PE and the common electrode CE may be electrodes through which a light may pass. The pixel electrode PE and the common electrode CE may include oxides, such as ITO, SnO₂, ZnO₂ or the like.

A polarization plate Pol may be disposed on the second base substrate BS2. According to the angle between the transmission axis of the polarization plate Pol and the long axis of liquid crystal molecules in the liquid crystal layer LC, the SLM 300 may modulate any one of the phase and amplitude of a light to output a hologram image. For example, it is assumed that the liquid crystal molecules of the liquid crystal layer LC are horizontally oriented in parallel to the first base substrate BS1 and the second base substrate BS2. When the angle between the long axis of the liquid crystals and the transmission axis of the polarization plate is 0□, the SLM 300 may module the phase of an incident light to output a hologram image. Also, when the angle between the long axis of the liquid crystals and the transmission axis of the polarization plate is 45°, the SLM 300 may module the amplitude of a light to output a hologram image.

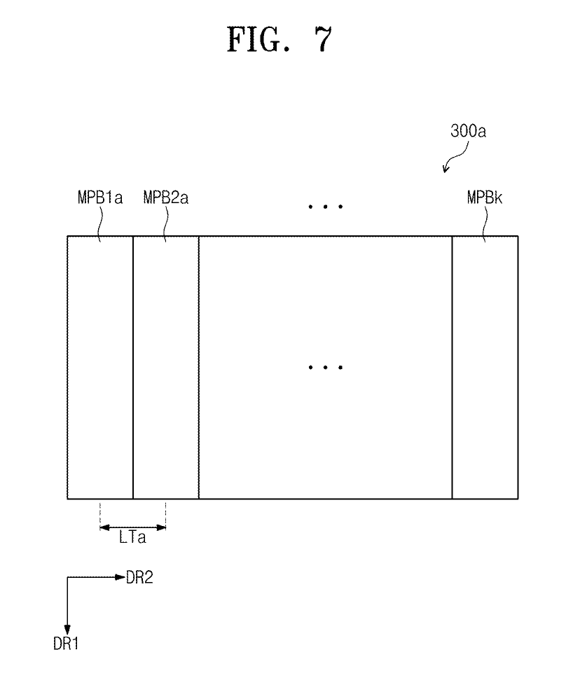

FIG. 7 is a schematic block diagram of an SLM according to an embodiment of the inventive concept.

When compared to the SLM 300 of FIG. 3, an SLM 300a of FIG. 7 has a difference in arrangement of a plurality of pixel groups MPB1a to MPBk. Each of the plurality of pixel groups MPB1a to MPBk of FIG. 7 may be extended in a first direction DR1 and the plurality of pixel groups MPB1a to MPBk may be arranged side by side in a second direction DR2.

The pitch LTa between two adjacent pixel groups, e.g., a first pixel group MPB1a and a second pixel group MPB2a, among the plurality of pixel groups MPB1a to MPBk may be smaller than the value RX calculated by Equation (1). As described in FIG. 5, Dst may be the distance between the holographic display device HDD (in FIG. 5) and the preset virtual user US (in FIG. 5).

$$RX = π \times \frac{1}{180} \times \frac{1}{60} \times Dst . \qquad ( 1 )$$

According to the holographic display device of the inventive concept, it is possible to use a single light source and a single spatial light modulation panel to implement a color hologram. Thus, the configuration of the holographic display device may be simplified.

Also, the SLM includes a plurality of pixel groups. The pitch between two adjacent pixel groups among the plurality of pixel groups may have a value that is invisible to a user due to decomposition. Thus, the user may easily view a color hologram image displaying a white screen as the background.

While exemplary embodiments of the inventive concept are described above, a person skilled in the art may understand that many modifications and variations may be implemented without departing from the spirit and technical scope of the inventive concept defined in the following claims. Thus, the technical scope of the inventive concept is not limited to matters described in the detailed description but should be defined by the following claims.

What is claimed is:

1. A holographic display device comprising:
a light source unit configured to emit a light; and
a spatial light modulator (SLM) configured to modulate at least one of a phase or amplitude of the light emitted from the light source unit to output a hologram image, and comprising a plurality of pixel groups that are arranged in a first direction, wherein each of the plurality of pixel groups comprises:
first pixels arranged in a matrix x1×y1 (where x1 and y1 are positive integers equal to or larger than 2) and providing an image having a first wavelength; and
second pixels adjacent to the first pixels in the first direction, arranged in a matrix x2×y2 (where x2 and y2 are positive integers equal to or larger than 2), and providing an image having a second wavelength that is different from the first wavelength.

2. The holographic display device of claim 1, wherein each of the plurality of pixel groups further comprises third pixels that are adjacent to the second pixels in the first direction, arranged in a x3×y3 matrix (where x3 and y3 are positive integers equal to or larger than 2), and provide an image having a third wavelength that is different from the first wavelength and the second wavelength.

3. The holographic display device of claim 2, wherein the image having the first wavelength is a blue image,
the image having the second wavelength is a green image, and
the image having the third wavelength is a red image.

4. The holographic image device of claim 1, wherein a pitch between a first pixel group, any one of the plurality of pixel groups and a second pixel group adjacent to the first pixel group is defined as a first pitch, and the first pitch is smaller than RX calculated by Equation (1):
$$RX = π \times \frac{1}{180} \times \frac{1}{60} \times Dst \qquad ( 1 )$$
where Dst is a distance between the holographic display device a preset virtual user who watches the holographic display device.

5. The holographic display device of claim 1, wherein the SLM comprises:
a first base substrate;
a light reflection layer disposed on the first base substrate;
a wavelength conversion layer disposed on the light reflection layer;
a pixel electrode disposed on the wavelength conversion layer;
a liquid crystal layer disposed on the pixel electrode; and
a common electrode disposed on the liquid crystal layer.

6. The holographic display device of claim 5, wherein the wavelength conversion layer comprises a first wavelength conversion layer disposed to overlap with the first pixels, and a second wavelength conversion layer disposed to overlap with the second pixels, and a thickness of the first wavelength conversion layer and a thickness of the second wavelength conversion layer are different from each other.

7. The holographic display device of claim 6, wherein the thickness of the first wavelength conversion layer is an integer multiple of half the first wavelength, and the thickness of the second wavelength conversion layer is an integer multiple of half the second wavelength.

8. The holographic display device of claim 5, wherein the pixel electrode comprises a transparent material.

9. The holographic display device of claim 5, wherein the wavelength conversion layer comprises:
a first material layer; and
a second material layer having a refractive index different from the first material layer, and
the first material layer and the second material layer are alternately stacked one or more times.

10. The holographic display device of claim 9, wherein each of the first material layer and the second material layer comprises an inorganic material.

11. The holographic display device of claim 9, wherein the first material layer comprises metal and the second material layer comprises an inorganic material.

12. The holographic display device of claim 11, wherein the first material layer has a first thickness, and the second material layer has a second thickness thicker than the first thickness.

13. The holographic display device of claim 1, wherein a light provided by the light source unit is a white light.

14. The holographic display device of claim 1, wherein the hologram image is a color hologram image.

15. The holographic display device of claim 1, wherein first x1 pixels arranged in a row direction among the first pixels are arranged in the first direction, and first y1 pixels arranged in a column direction among the first pixels are arranged in a second direction intersecting with the first direction,
second x2 pixels arranged in a row direction among the second pixels are arranged in the first direction, and second y2 pixels arranged in a column direction among the second pixels are arranged in a second direction, and the number of the first y1 pixels arranged in the second direction among the first pixels is a same as the number of the second y2 pixels arranged in the second direction among the second pixels.
